(19) United States
(12) Patent Application Publication
(10) Pub. No.: US 2023/0188995 A1
(43) Pub. Date: Jun. 15, 2023

(54) INTEGRITY PROTECTION METHOD AND SYSTEM

(71) Applicant: VIVO MOBILE COMMUNICATION CO., LTD., Dongguan (CN)

(72) Inventor: Yuanyuan WANG, Dongguan (CN)

(73) Assignee: VIVO MOBILE COMMUNICATION CO., LTD., Dongguan (CN)

(21) Appl. No.: 18/107,499

(22) Filed: Feb. 8, 2023

Related U.S. Application Data
(63) Continuation of application No. PCT/CN2021/111599, filed on Aug. 9, 2021.

(30) Foreign Application Priority Data
Aug. 11, 2020 (CN) 202010803299.X

(51) Int. Cl. H04W 12/104; H04W 64/00; H04W 12/12

(52) U.S. Cl. CPC H04W 12/104; H04W 64/00; H04W 12/12

(57) ABSTRACT

An integrity protection method and system are provided. The method includes: calculating, by an integrity protection system, first information; and performing an integrity check by using the first information to determine the degree of reliability of a target system. The first information is calculated according to at least one of the following: sampling data of a first communication device, sampling data of a second communication device, or target risk tolerance. The target system includes the first communication device and the second communication device.

### CROSS-REFERENCE TO RELATED APPLICATIONS

This application is a continuation of International Application No. PCT/CN2021/111599, filed on Aug. 9, 2021, which claims priority to Chinese Patent Application No. 202010803299.X, filed on Aug. 11, 2020. The entire contents of each of the above-referenced applications are expressly incorporated herein by reference.

### TECHNICAL FIELD

The present application belongs to the technical field of communications, and in particular, relates to an integrity protection method and system.

### BACKGROUND

With the rapid development of 5G positioning technology, the fields of road toll collection, Internet of Vehicles, and even aviation are trying to introduce 5G positioning technology as the main means of positioning. However, the current mobile communication system does not provide an integrity protection function, which easily causes the problem of low positioning reliability.

### SUMMARY

Embodiments of the present application provide an integrity protection method and system.

In a first aspect, an integrity protection method is provided, where the method includes: calculating, by an integrity protection system, first information; and performing an integrity check by using the first information to determine the degree of reliability of a target system; where the first information is calculated according to at least one of the following: sampling data of a first communication device, sampling data of a second communication device, and target risk tolerance; and the target system includes the first communication device and the second communication device.

In a second aspect, an integrity protection system is provided, where the system includes: a calculation module, configured to calculate first information; and an integrity check module, configured to perform an integrity check by using the first information to determine the degree of reliability of a target system; where the first information is calculated according to at least one of the following: sampling data of a first communication device, sampling data of a second communication device, and target risk tolerance; and the target system includes the first communication device and the second communication device.

In a third aspect, an integrity protection system is provided, including a processor, a memory, and programs or instructions stored in the memory and executable on the processor, where the programs or the instructions, when executed by the processor, implement the method according to the first aspect.

In a fourth aspect, a readable storage medium is provided, storing programs or instructions, where the programs or the instructions, when executed by a processor, implement the method according to the first aspect.

In a fifth aspect, a computer program product is provided, including a processor, a memory, and programs or instructions stored in the memory and executable on the processor, where the programs or the instructions, when executed by the processor, implement the method according to the first aspect.

In a sixth aspect, a chip is provided, including a processor and a communication interface. The communication interface is coupled to the processor, and the processor is configured to run a program or an instruction to implement the method provided in the first aspect.

In the embodiments of the present application, the integrity protection system calculates the first information, and performs an integrity check based on the first information to determine the degree of reliability of the target system. The target system includes the first communication device and the second communication device. The information is calculated according to at least one of the following: sampling data of the first communication device, sampling data of the second communication device, and target risk tolerance. The embodiments implement the integrity protection function in the mobile communication system, which can improve the positioning reliability of the mobile communication system, improve the security of positioning applications, and make the application scenarios of wireless communication more extensive.

### BRIEF DESCRIPTION OF DRAWINGS

FIG. 1 is a block diagram of a wireless communication system according to an embodiment of the present application;

FIG. 2 is a schematic flowchart of an integrity protection method according to an embodiment of the present application;

FIG. 3 is a schematic flowchart of an integrity protection method according to an embodiment of the present application;

FIG. 4 is a schematic flowchart of an integrity protection method according to another embodiment of the present application;

FIG. 5 is a schematic flowchart of an integrity protection method according to yet another embodiment of the present application;

FIG. 6 is a schematic structural diagram of an integrity protection system according to an embodiment of the present application;

FIG. 7 is a schematic structural diagram of a communication device according to an embodiment of the present application;

FIG. 8 is a schematic structural diagram of a terminal according to an embodiment of the present application; and

FIG. 9 is a schematic structural diagram of a network side device according to an embodiment of the present application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

The terms “first”, “second”, and the like in this specification and claims of this application are used to distinguish between similar objects instead of describing a specific order or sequence. It should be understood that, data used in this way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and a character “/” generally represents an “or” relationship between associated objects.

It should be noted that the technology described in the embodiments of this application is not limited to a Long Term Evolution (LTE)/LTE-Advanced (LTE-A) system, and may also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” in the embodiments of this application may be used interchangeably. The described technologies can be applied to both the systems and the radio technologies mentioned above as well as to other systems and radio technologies. However, a New Radio (NR) system is described in the following description for illustrative purposes, and the NR terminology is used in most of the following description, although these technologies can also be applied to applications other than the NR system application, such as the 6th Generation (6G) communication system.

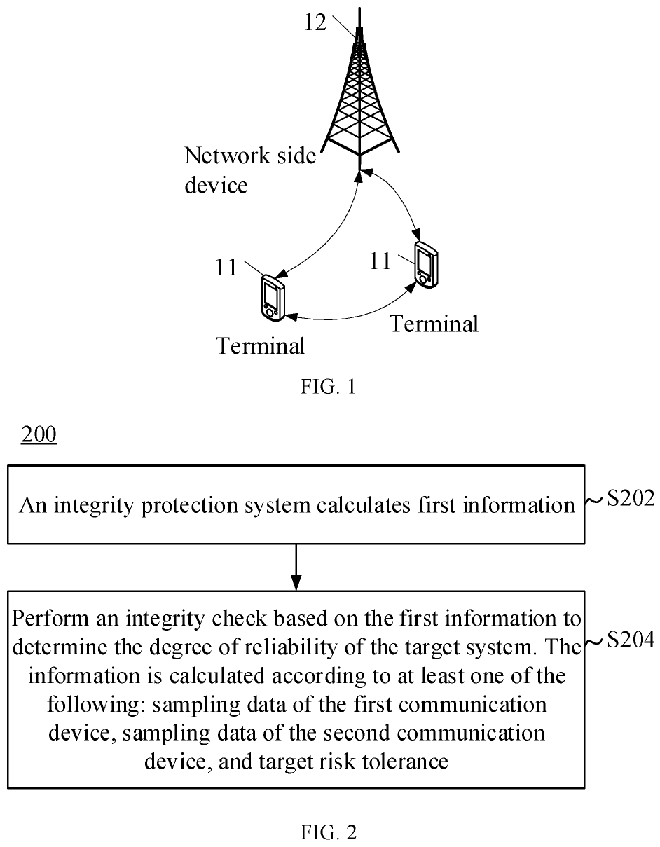

FIG. 1 is a block diagram of a wireless communications system to which embodiments of this application can be applied. The wireless communications system includes a terminal 11 and a network side device 12. The terminal 11 may also be referred to as a terminal device or User Equipment (UE). The terminal 11 may be a terminal side device such as a mobile phone, a tablet personal computer, or a laptop computer, or called a notebook computer, a Personal Digital Assistant (PDA), a palmtop computer, a netbook, an Ultra Mobile Personal Computer (UMPC), a Mobile Internet Device (MID), a wearable device, a Vehicle User Equipment (VUE), or a Pedestrian User Equipment (PUE). The wearable device includes bracelets, headphones, glasses, etc. It should be noted that a type of the terminal 11 is not limited in the embodiments of this application. The network side device 12 may be a base station or a core network device, and the base station may be referred to as a NodeB, an evolved NodeB (eNB), an access point, a Base Transceiver Station (BTS), a radio base station, a radio transceiver, a Basic Service Set (BSS), an Extended Service Set (ESS), a NodeB, an eNB, a home NodeB, a home evolved NodeB, a WLAN access point, a WiFi node, a Transmitting Receiving Point (TRP), or another appropriate term in the art. Provided that the same technical effect is achieved, the base station is not limited to specific technical vocabulary. It should be noted that the base station in an NR system is merely used as an example, but a type of the base station is not limited in the embodiments of this application.

The integrity protection method and system provided by the embodiments of the present application will be described in detail below with reference to the accompanying drawings through embodiments and application scenarios thereof.

As shown in FIG. 2, an embodiment of the present application provides an integrity protection method 200. The method includes the following steps.

S202: The integrity protection system calculates first information.

S204: The integrity protection system performs an integrity check based on the first information to determine the degree of reliability of the target system. The information is calculated according to at least one of the following: sampling data of the first communication device, sampling data of the second communication device, and target risk tolerance.

The integrity protection system mentioned in each embodiment of the present application may be a submodule/sub-apparatus/sub-device in the first communication device; and may also be a submodule/sub-apparatus/sub-device in the second communication device; and may also be a module/apparatus/device that is independent of the first communication device and the second communication device, and capable of communication connection with the first communication device and the second communication device. It can be understood that the integrity protection system may be installed in both the first communication device and the second communication device.

In various embodiments of the present application, the first communication device may be a terminal or a network side device; similarly, the second communication device may be a terminal or a network side device. Subsequent embodiments mainly use an example in which the first communication device is a terminal and the second communication device is a network side device. In this scenario, the terminal can realize its own positioning through the network side device. This embodiment does not limit the specific positioning method, for example, the Time Of Arrival (TOA) positioning method.

The target system may be a positioning system composed of a first communication device and a second communication device; therefore, the target system includes the first communication device and the second communication device. It can be understood that, in addition to realizing the positioning of the first communication device or the second communication device, the target system can also realize other functions, such as measuring the moving speed of the first communication device or the second communication device; correcting/synchronizing clock information of the first communication device or the second communication device, etc.

The first information may be error information; the sampling data may be data that can cause/cause positioning errors, for example, including clock synchronization information, system correction information, interference conditions, occlusion conditions, refraction conditions, etc.

In an example, the first communication device is a terminal, the second communication device is a network side device, and the integrity protection system is set in the terminal. In this example, the network side device provides sampling data to the terminal, and the sampling data includes positioning assistance data, etc., and may include the aforementioned data that can cause/cause positioning errors.

After receiving the sampling data from the network side device, the terminal provides the sampling data to the integrity protection system, and the integrity protection system calculates the first information according to the sampling data, target risk tolerance, and the like. In this example, the first information may be a positioning integrity protection level corresponding to the obtained position information. In some embodiments, when the integrity protection system determines that the positioning integrity protection level is greater than the positioning integrity risk alarm level, an alarm is issued to prompt the user that the current location information is unreliable.

The target risk tolerance mentioned above may be provided by the terminal; may also be provided by the network side device; may also be provided by other applications, and may also be a pre-configured value. The target risk tolerance is usually a fixed value, for example, the target risk tolerance is: safety 99.9999%, or risk 0.0000000001.

It can be understood that, in other embodiments, the first communication device is a terminal, the second communication device is a network side device, and the integrity protection system may also be set in the network side device. In this example, the network side device realizes its own positioning according to the terminal, and the terminal can provide sampling data to the network side device, and the network side device performs integrity protection for its own location information through the integrity protection system. For implementation methods, refer to the introduction in the foregoing embodiment.

In the integrity protection method provided in the embodiments of the present application, the integrity protection system calculates the first information, and performs an integrity check based on the first information to determine the degree of reliability of the target system. The target system includes the first communication device and the second communication device. The information is calculated according to at least one of the following: sampling data of the first communication device, sampling data of the second communication device, and target risk tolerance. The embodiments implement the integrity protection function in the mobile communication system, which can improve the positioning reliability of the mobile communication system, improve the security of positioning applications, and make the application scenarios of wireless communication more extensive.

For example, the first information mentioned in embodiment 200 may be used to indicate at least one of the following:

1) Whether there is abnormal data in the sampling data.

2) Whether the first communication device fails.

3) Whether the second communication device fails.

4) Whether the target system fails.

In order to describe the above four situations in detail, an example will be used for explanation below. In an example, the first communication device is a terminal, the second communication device is a network side device, and the integrity protection system is set in the terminal. In this example, the network side device provides sampling data to the terminal. In this example, the terminal may receive sampling data from multiple network side devices for its own positioning, and at the same time for calculating the first information through the integrity protection system and determining the degree of reliability of the positioning system.

In this example, the integrity protection system can use the first information to indicate whether there is abnormal data in the sampled data, and the abnormal data can be eliminated in the subsequent positioning process to improve the reliability of positioning.

In this example, the integrity protection system may use the first information to indicate whether the first communication device fails. For example, the first information indicates that an error has occurred in the terminal itself, and an alarm message is issued in time. In this example, the integrity protection system can detect the positioning error of the terminal itself, further improving the reliability of positioning.

In this example, the integrity protection system can use the first information to indicate whether the second communication device is faulty, for example, indicating that there is a faulty network side device, etc., and then the faulty network side device is eliminated (that is, the faulty network side device is no longer used for positioning), which improves the reliability of positioning.

In this example, the integrity protection system may use the first information to indicate whether the target system fails. For example, the first information indicates that the positioning system formed by the terminal and the network side device fails, and an alarm message is sent in time to further improve the reliability of positioning.

As mentioned above, in addition to realizing the positioning of the first communication device or the second communication device, the target system can also realize other functions, such as measuring the moving speed of the first communication device or the second communication device; correcting/synchronizing clock information of the first communication device or the second communication device, etc. Therefore, the first information mentioned in each embodiment of the present application is used to perform integrity protection on at least one of the following: location information, speed information, and clock information of the first communication device. In this example, the first communication device may be a terminal and the second communication device may be a network side device.

The first information mentioned in the above embodiment is used to perform integrity protection on the location information, and the above embodiment also includes the following steps: the integrity protection system receives the second information, and the second information includes at least one of the following 1) positioning auxiliary data; 2) positioning integrity risk; 3) positioning integrity protection level; 4) positioning integrity risk alarm level; 5) positioning integrity risk event reporting time; 6) positioning integrity protection threshold; 7) positioning accuracy requirements; and 8) integrity index requirements.

In the above-mentioned embodiment, the receiving the second information by the integrity protection system includes: the integrity protection system receives the second information in at least one of the following ways: 1) receiving the second information through paging signaling; 2) receiving the second information through IP data packets; 3) receiving the second information through positioning protocol; 4) receiving the second information through broadcast.

In this embodiment, the first communication device may be a terminal, the second communication device may be a network side device, the integrity protection system is set in the terminal, and the network side device transmits the second information to the terminal through at least one of the four methods.

In this embodiment, when the integrity protection system obtains that the positioning integrity protection level is greater than the positioning integrity risk alarm level, the integrity protection system may also issue an alarm to remind the user that the current location information is unreliable.

For example, for the positioning integrity protection level and positioning integrity risk alarm level mentioned in the above embodiments, there are the following four ways of providing: 1) the positioning integrity protection level is provided by the first communication device, and the positioning integrity risk alarm level is provided by the second communication device; or 2) the positioning integrity protection level is provided by the second communication device, and the positioning integrity risk alarm level is the provided by the first communication device; or 3) the positioning integrity protection level is provided by the first communication device, and the positioning integrity risk alarm level is provided by the first communication device; 4) the positioning integrity protection level is provided by the second communication device, and the positioning integrity risk alarm level is provided by the second communication device.

For example, the first information mentioned in the foregoing embodiments is used to perform integrity protection on the location information of the first communication device, and the performing an integrity check through the first information to determine the degree of reliability of the target system includes: performing an integrity check by using the first information and at least one of the following to determine the degree of reliability of the target system: orbit information and map information of the first communication device.

In this embodiment, the data analysis and correction process of the integrity protection system can be comprehensively compared with track information and/or map information of the terminal (such as waterway information, railway track maps, Gaode maps, etc.) to improve the integrity protection accuracy of location information.

In an example, the first communication device is a terminal, the second communication device is a network side device, and the integrity protection system is set in the terminal. In this example, the network side device provides sampling data to the terminal, and the sampling data includes positioning assistance data, etc., and may include the aforementioned data that can cause/cause positioning errors. The first communication device may also send third information to the second network side device, where the third information includes at least one of the following:

1) First message.

2) Integrity protection information used by the integrity protection system. The integrity protection information may also be referred to as a check method used by the integrity protection system.

3) Checked first information. In this example, the first information may also include location information, speed information, or clock information of the terminal, and the integrity protection system may check/correct the first information to provide more accurate first information.

4) Alarm information. Usually, the terminal sends an alarm when the positioning integrity protection level is greater than the positioning integrity risk alarm level. Therefore, the alarm information may include the positioning integrity protection level, the positioning integrity risk alarm level, the alarm time, and location information corresponding to the alarm (that is, the location information may not be accurate), etc.

5) Integrity check information used by the integrity protection system.

In an example, the terminal can report unchecked location information to the network side device. The network side device is equipped with an integrity protection system, and the integrity protection system of the network side device checks the location information and provides the third information to the terminal.

It should be noted that the integrity protection system provided by each embodiment of the present application is not limited to the terminal checking its own location information. There are also integrity protection systems on the network side device and the location server to perform integrity protection on received data. For example, there are the following situations: the terminal corrects the network side device; the network-side device corrects the terminal; the terminal corrects other terminals; and network system 1 corrects network system 2.

In some embodiments, the check method used by the integrity protection system includes at least one of the following: first-order Markov process; error model; two-dimensional reverse normal distribution; Bayesian statistical method; least square method; Kalman filtering; and Neyman-Pearson's theorem.

In some embodiments, the integrity check information used by the integrity protection system mentioned in 5) above may include at least one of the following: 1) positioning assistance data; 2) positioning integrity risks; 3) positioning integrity protection level; 4) positioning integrity risk alarm level; 5) positioning integrity risk event reporting time; 6) positioning integrity protection threshold; 7) positioning accuracy requirements; and 8) integrity index requirements.

In an example, the check method used by the integrity protection system includes a Bayesian statistical method. In this example, the integrity protection system includes a Bayesian prediction model, and the Bayesian prediction model predicts based on Bayesian statistics. Bayesian statistics is different from general statistical methods, and not only uses model information and data information, but also makes full use of prior information.

For single-time location information (or location data), the location information may be first input into the Bayesian model, to evaluate the reliability of the location information. In a case that the obtained positioning integrity protection level corresponding to the location information is greater than the positioning integrity a risk alarm level, an alarm can also be issued; in a case that the obtained positioning integrity protection level corresponding to the location information is less than or equal to the positioning integrity risk alarm level, return to the Bayesian model for iterative analysis. It can be understood that the greater the amount of sampling data, the more accurate the obtained result (such as location information).

In some embodiments, when the location data is checked by the integrity protection system and it is found that the single-time data does not meet the integrity check, the system will give an alarm. For example, if a user positions a location area, positioning of most other users is concentrated within a certain range, and location data of positioning of this user exceeds this range, it is considered that a location data error of the user is relatively large. The alarm information is notified to the terminal via the integrity protection system, and the terminal reports the information to the network side or the positioning application server.

For example, the first communication device and the second communication device mentioned in the foregoing embodiments meet one of the following requirements: 1) the first communication device is a terminal, and the second communication device is a network side device; 2) the first communication device is a network side device, and the second communication device is a terminal; 3) the first communication device is a terminal, and the second communication device is a terminal; 4) the first communication device is a network side device, and the second communication device is a network side device.

The network side device includes at least one of the following: a radio access network side; an Authentication Management Function (AMF); a Location Management Function (LMF); a positioning server; a positioning application; a satellite positioning system (e.g., Global Navigation Satellite System (GNSS)) correction system; and an integrity correction system, such as a Receiver Autonomous Integrity Monitoring (RAIM) system.

In some embodiments, integrity capability intercommunication can be realized between at least two of the foregoing network side devices, and the intercommunication manner includes at least one of the following: 1) interface signaling intercommunication; 2) data server sharing.

The data server sharing mentioned above may mean that by establishing a data server, all the network side devices mentioned above can be set up on the data server interface, and data sharing can be performed by directly reading data. In this way, permissions can also be set for access modules (such as all network side devices mentioned above), including but not limited to at least one of the following: read-only; writable; partially read-only; partially writable.

In some embodiments, the terminal is further configured to report the integrity capability of the terminal to the network side device through at least one of the following methods: 1) reporting the integrity capability through signaling; 2) reporting the integrity capability through IP data packets; 3) reporting the integrity capability through positioning protocol.

In some embodiments, the network side device is further configured to notify the terminal of the integrity capability of the network side device through at least one of the following methods: 1) notifying the integrity capability through paging signaling; 2) notifying the integrity capability through IP data packets; 3) notifying the integrity capability through positioning protocol; 4) notifying the integrity capability through broadcast.

It should be noted that the integrity capabilities mentioned in the various embodiments of this specification may include four types: low integrity requirements (low); high integrity requirements (high); medium integrity requirements (medium); no integrity requirements.

In some embodiments, the network side device is further configured to notify the terminal of the error information of the network side device through signaling or broadcasting, so that the terminal can fully consider the error information when positioning.

In order to describe in detail the integrity protection method of the mobile communication system provided by the embodiments of the present application, the following will describe in conjunction with several embodiments.

### Embodiment 1

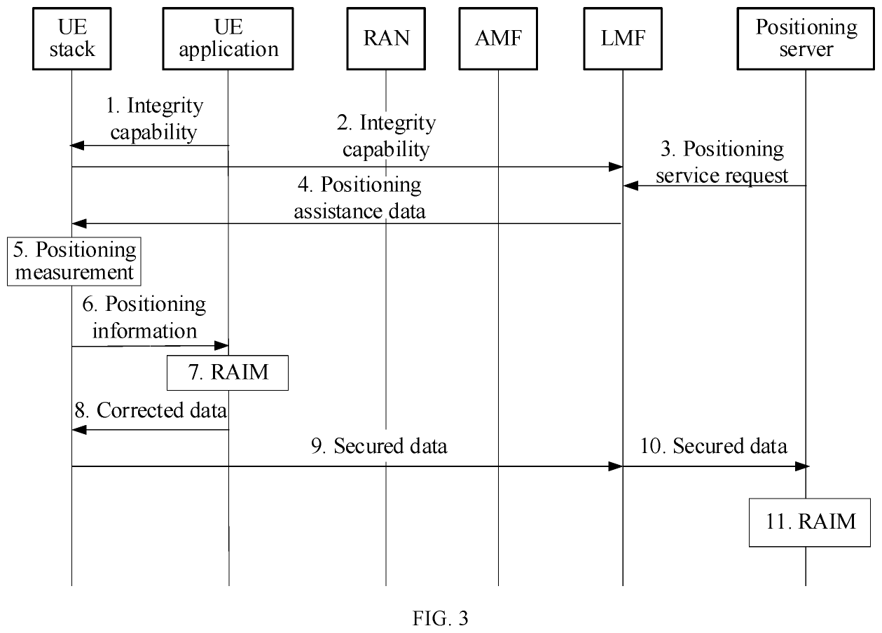

As shown in FIG. 3, this embodiment includes the following steps.

Step 1: UE acquires a integrity capability. In this embodiment, an integrity protection system is set in the UE.

Step 2: The UE reports its integrity capability to an LMF through the positioning protocol.

Step 3: The positioning process is initiated. For example, the location server may send a positioning service request to the LMF, so as to realize the positioning of the UE.

Step 4: The LMF sends the positioning assistance data to the UE, and at the same time, it can also carry the integrity capability supported by the LMF.

Step 5: The UE performs positioning measurement to obtain positioning information (or location information).

Step 6: The UE stack sends precise positioning information to the UE application.

Step 7: The integrity protection system corrects the positioning information. For the integrity protection system in this embodiment, refer to the RAIM in FIG. 3.

Step 8: The integrity protection system provides corrected positioning information (that is, the data that has been secured) to the UE stack.

Step 9: The UE stack sends the secured data to the LMF, for details, refer to the third information in the foregoing embodiments.

Step 10: The LMF sends the secured data to the positioning server.

Step 11: The integrity protection system may also exist on the positioning server side; therefore, the integrity protection system can also be configured to check the location information of a single UE and can also count the location information of multiple UEs.

### Embodiment 2

This embodiment is similar to the first embodiment, and in the second embodiment, it is not the UE and the network side device that perform positioning, but the UE and the UE. In the second embodiment, the accuracy of a single UE positioning is determined by sampling positioning information of a large number of UEs.

The UE1 in the second embodiment is equivalent to the UE in the first embodiment, and the UE2 in the second embodiment is equivalent to the network side device in the first embodiment, and the network side device includes an LMF and a positioning server.

### Embodiment 3

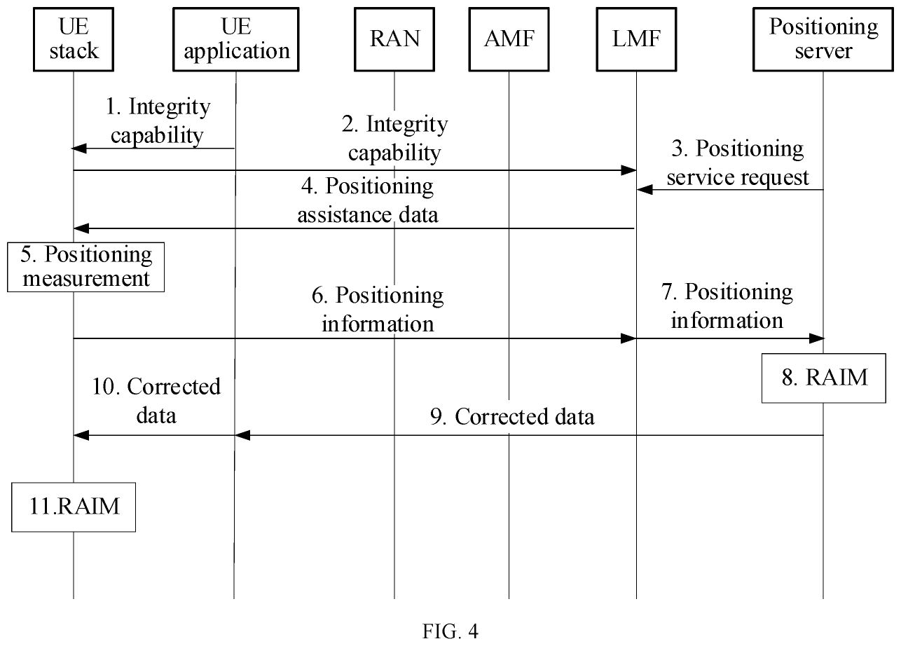

As shown in FIG. 4, this embodiment includes the following steps.

The difference between Embodiment 3 and Embodiment 1 starts from step 6. Unlike Embodiment 1, the measured positioning information in this embodiment is not checked for integrity on the UE side, but is reported by the UE to the network side device, and the network side device performs a complete security check, and then sends a check result back to the UE.

For steps 1 to 5 of this embodiment, refer to Embodiment 1, and the introduction will begin with step 6 below.

Step 6: The UE stack sends precise location information to the LMF.

Step 7: The LMF sends the precise positioning information to the positioning server. The integrity protection system in this embodiment can refer to the RAIM in FIG. 4, which is located at the positioning server side.

Step 8: The integrity protection system corrects the positioning information.

Step 9: The positioning server provides the corrected data (which may be corrected positioning information) to the UE application.

Step 10: The UE application provides the corrected data to the UE stack.

Step 11: The integrity protection system may also exist in the UE, therefore, the corrected data may also be corrected again to improve the accuracy of the positioning information.

### Embodiment 4

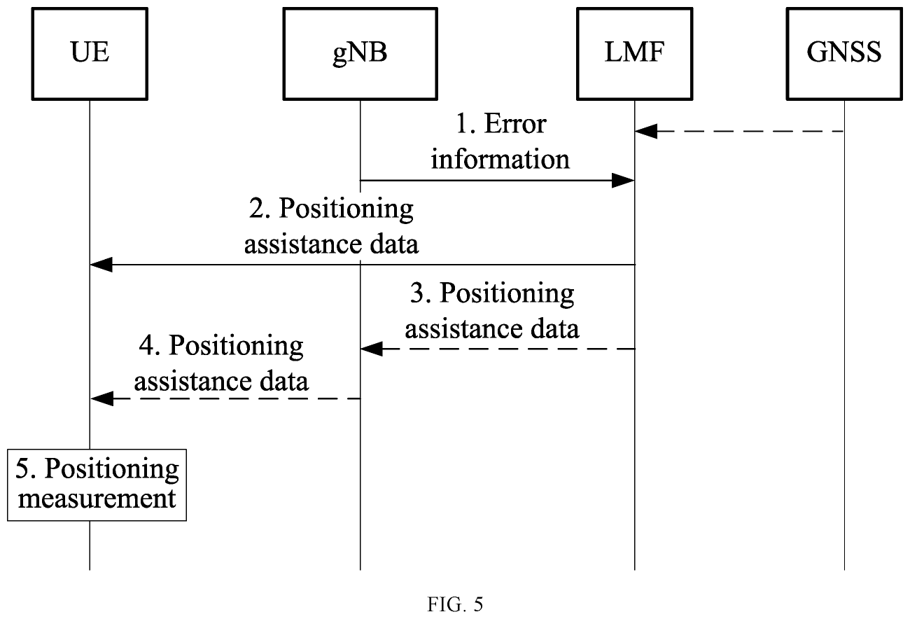

As shown in FIG. 5, this embodiment includes the following steps.

Step 1: The gNB sends its own error information to the LMF.

Step 2: When the UE is positioned, the LMF sends the positioning assistance data carrying the above error information to the UE, so that the UE can fully consider the error information when positioning.

In another implementation, as shown in steps 3 and 4 of FIG. 5, the LMF sends the positioning assistance data carrying the above error information to the gNB, and then the gNB forwards it to the UE, so that the terminal can fully consider the error information when positioning.

Step 5: The UE performs positioning measurements.

For the subsequent steps of this embodiment, reference may also be made to Step 6 to Step 11 of Embodiment 1.

It should be noted that, the integrity protection method provided in the embodiments of the present application may be executed by an integrity protection system, or a control module in the integrity protection system for executing the integrity protection method. In the embodiments of the present application, the integrity protection system provided in the embodiments of the present application is described by taking the integrity protection system executing the integrity protection method as an example.

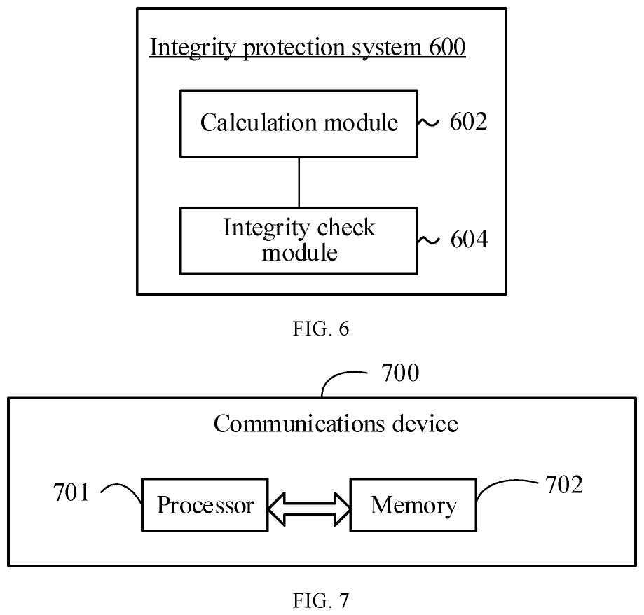

FIG. 6 is a schematic structural diagram of an integrity protection system according to an embodiment of the present application. As shown in FIG. 6, the integrity protection system 600 includes: a calculation module 602, configured to calculate first information; and an integrity check module 604, configured to perform an integrity check by using the first information to determine the degree of reliability of a target system; where the first information is calculated according to at least one of the following: sampling data of a first communication device, sampling data of a second communication device, and target risk tolerance; and the target system includes the first communication device and the second communication device.

In the embodiments of the present application, the integrity protection system calculates the first information, and performs an integrity check based on the first information to determine the degree of reliability of the target system. The target system includes the first communication device and the second communication device. The information is calculated according to at least one of the following: sampling data of the first communication device, sampling data of the second communication device, and target risk tolerance. The embodiments implement the integrity protection function in the mobile communication system, which can improve the positioning reliability of the mobile communication system, improve the security of positioning applications, and make the application scenarios of wireless communication more extensive.

For example, as an embodiment, the first information is used to indicate at least one of the following: whether there is abnormal data in the sampling data; whether the first communication device fails; whether the second communication device fails; and whether the target system fails.

For example, as an embodiment, the first information is used for integrity protection of at least one of the following: location information, speed information, and clock information of the first communication device.

For example, as an embodiment, the first information is used for integrity protection of the location information, and the system 600 further includes: a receiving module, configured to: receive the second information, and the second information includes at least one of the following positioning auxiliary data; positioning integrity risk; positioning integrity protection level; positioning integrity risk alarm level; positioning integrity risk event reporting time; positioning integrity protection threshold; positioning accuracy requirements; and integrity index requirements.

For example, as an embodiment, the receiving module is configured to receive the second information through at least one of the following methods: receiving the second information through paging signaling; receiving the second information through IP data packets; receiving the second information through positioning protocols; and receiving the second information through broadcast.

For example, as an embodiment, the integrity verification module 604 is further configured to: issue an alarm in a case that the obtained positioning integrity protection level is greater than the positioning integrity risk alarm level.

For example, as an embodiment, the first information is used to perform integrity protection on the location information, and the integrity check module 604 is configured to: performing integrity check based on the first information and at least one of orbit information and map information of the first communication device, to determine the degree of reliability of the target system.

For example, as an embodiment, the system 600 further includes: a sending module, configured to send third information to the second network side device, where the third information includes at least one of the following: the first information; the integrity protection information used by the integrity protection system; the checked first information; alarm information; and the integrity check information used by the integrity protection system.

For example, as an embodiment, the check method used by the integrity protection system 600 includes at least one of the following: first-order Markov process; error model; two-dimensional reverse normal distribution; Bayesian statistical method; least square method; Filtering; and Neyman-Pearson's theorem.

For example, as an embodiment, the first communication device and the second communication device meet one of the following requirements: the first communication device is a terminal, and the second communication device is a network side device; the first communication device is a network side device, and the second communication device is a terminal; the first communication device is a terminal, and the second communication device is a terminal; the first communication device is a network side device, and the second communication device is a network side device.

For example, as an embodiment, the terminal is further configured to report the integrity capability of the terminal to the network side device through at least one of the following methods: reporting the integrity capability through signaling; reporting the integrity capability through IP data packets; reporting the integrity capability through positioning protocol.

For example, as an embodiment, the network side device is further configured to notify the terminal of the integrity capability of the network-side device through at least one of the following methods: notifying the integrity capability through paging signaling; notifying the integrity capability through IP data packets; notifying the integrity capability by positioning protocol; notifying the integrity capability by broadcast.

For example, as an embodiment, the network side device is further configured to notify the terminal of the error information of the network side device through signaling or broadcasting.

For the integrity protection system 600 according to the embodiments of the present application, refer to the procedure corresponding to the method 200 according to the embodiments of the present application. Furthermore, each unit/module of the integrity protection system 600 and the foregoing other operations and/or functions are used to implement the corresponding procedure of the method 200, can achieve the same or equivalent technical effect, and will no longer be described here for the purpose of brevity.

The integrity protection system in this embodiment of this application may be an apparatus, or a component, an integrated circuit, or a chip in a terminal. The apparatus may be a mobile terminal, or a non-mobile terminal. For example, mobile terminals can include, but are not limited to, the types of terminals 11 listed above. Non-mobile terminals can be servers, Network Attached Storage (NAS), Personal Computers (PCs), Televisions (TVs), teller machines or self-service machines. The embodiments of the application are not specifically defined.

The integrity protection system in this embodiment of the present application may be an apparatus with an operating system. The operating system may be an Android operating system, an iOS operating system, or another possible operating system. This is not specifically limited in the embodiments of this application.

The integrity protection system provided by the embodiment of the application can realize each process of the method embodiments of FIG. 2 to FIG. 5, and achieve the same technical effect. To avoid repetition, it will not be repeated herein.

For example, as shown in FIG. 7, the embodiments of the present application also provide a communication device 700, which includes a processor 701, a memory 702, and programs or instructions stored in the memory 702 and executable on the processor 701. For example, when the communication device 700 is a terminal, the programs or instructions are executed by the processor 701 to realize the processes of the integrity protection method embodiment and achieve the same technical effect. When the communications device 700 is a network side device, the programs or instructions are executed by the processor 701 to perform the processes of the embodiment of the integrity protection method, and the same technical effect can be achieved, which are not repeated herein to avoid repetition.

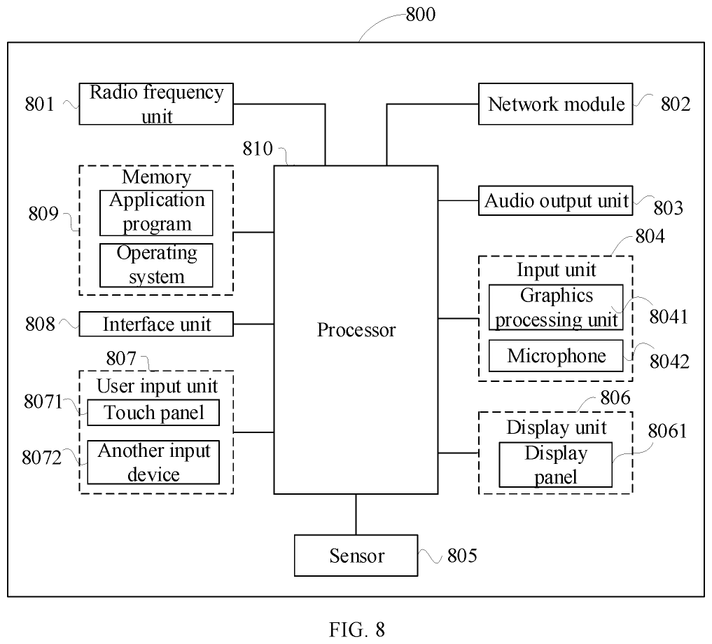

FIG. 8 is a schematic diagram of a hardware structure of a terminal according to an embodiment of this application.

The terminal 800 includes but is not limited to components such as a radio frequency unit 801, a network module 802, an audio output unit 803, an input unit 804, a sensor 805, a display unit 806, a user input unit 807, an interface unit 808, a memory 809, and a processor 810.

It may be understood by a person skilled in the art that the terminal 800 may further include a power supply (such as a battery) that supplies power to each component. The power supply may be logically connected to the processor 810 by using a power management system, to implement functions such as charging, discharging, and power consumption management by using the power management system. The terminal structure shown in FIG. 8 constitutes no limitation on the terminal, and the terminal may include more or fewer components than those shown in the figure, or combine some components, or have different component arrangements. Details are not described herein.

It should be understood that in this embodiment of the present application, the input unit 804 may include a Graphics Processing Unit (GPU) 8041 and a microphone 8042, and the GPU 8041 processes image data of a still picture or a video obtained by an image capture apparatus (such as a camera) in a video capture mode or an image capture mode. The display unit 806 may include a display panel 8061, and the display panel 8061 may be configured in a form of a liquid crystal display, an organic light emitting diode, or the like. The user input unit 807 includes a touch panel 8071 and another input device 8072. The touch panel 8071 is also referred to as a touch screen. The touch panel 8071 may include two parts: a touch detection apparatus and a touch controller. The another input device 8072 may include but is not limited to a physical keyboard, a functional button (such as a volume control button or a power on/off button), a trackball, a mouse, and a joystick. Details are not described herein.

In this embodiment of this application, the radio frequency unit 801 receives downlink data from a network side device and then sends the downlink data to the processor 810 for processing; and sends uplink data to the network side device. Usually, the radio frequency unit 801 includes but is not limited to an antenna, at least one amplifier, a transceiver, a coupler, a low noise amplifier, a duplexer, and the like.

The memory 809 may be configured to store a software program or an instruction and various data. The memory 809 may mainly include a program or instruction storage area and a data storage area. The program or instruction storage area may store an operating system, and an application or an instruction required by at least one function (for example, a sound playing function or an image playing function). In addition, the memory 809 may include a high-speed random access memory and a non-volatile memory. The nonvolatile memory may be a Read-only Memory (ROM), a Programmable ROM (PROM), an Erasable PROM (EPROM), an Electrically EPROM (EEPROM), or a flash memory. For example, at least one disk storage component, a flash memory component, or another non-volatile solid-state storage component.

The processor 810 may include one or more processing units. In some embodiments, an application processor and a modem processor may be integrated into the processor 810. The application processor mainly processes an operating system, a user interface, an application, an instruction, or the like. The modem processor mainly processes wireless communications, for example, a baseband processor. It can be understood that the modem processor may not be integrated into the processor 810.

The processor 810 is configured to calculate first information; and perform an integrity check by using the first information to determine the degree of reliability of a target system; where the first information is calculated according to at least one of the following: sampling data of a first communication device, sampling data of a second communication device, and target risk tolerance; and the target system includes the first communication device and the second communication device.

In the embodiments of the present application, the integrity protection system of the terminal calculates the first information, and performs an integrity check based on the first information to determine the degree of reliability of the target system. The target system includes the first communication device and the second communication device. The information is calculated according to at least one of the following: sampling data of the first communication device, sampling data of the second communication device, and target risk tolerance. The embodiments implement the integrity protection function in the mobile communication system, which can improve the positioning reliability of the mobile communication system, improve the security of positioning applications, and make the application scenarios of wireless communication more extensive.

The terminal provided in this embodiment of the present disclosure can implement the processes of the embodiments of the foregoing integrity protection method, with the same technical effects achieved. To avoid repetition, details are not described again herein.

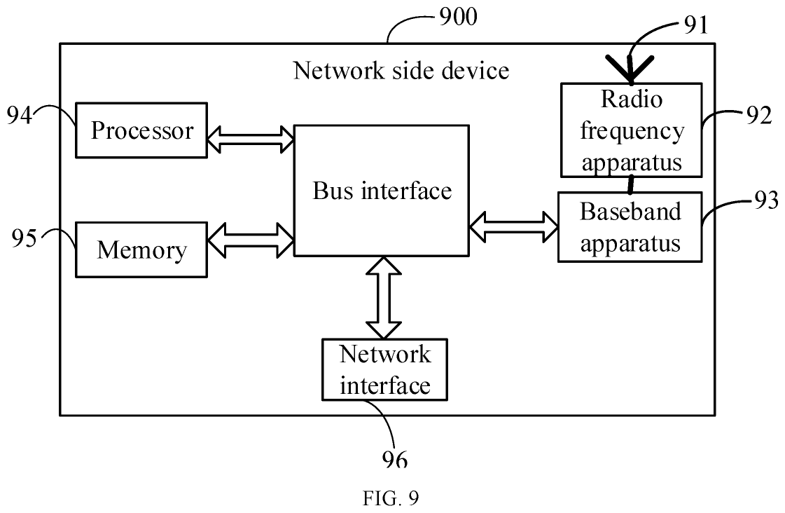

For example, an embodiment of this application further provides a network side device. As shown in FIG. 9, a network device 900 includes an antenna 91, a radio frequency apparatus 92, and a baseband apparatus 93. The antenna 91 is connected to the radio frequency apparatus 92. In an uplink direction, the radio frequency apparatus 92 receives information by using the antenna 91, and transmits the received information to the baseband apparatus 93 for processing. In a downlink direction, the baseband apparatus 93 processes information to be sent and sends the information to the radio frequency apparatus 92, and the radio frequency apparatus 92 processes the received information and sends the information through the antenna 91.

The frequency band processing apparatus may be located in the baseband apparatus 93. The method performed by the network-side device in the foregoing embodiment may be implemented in the baseband apparatus 93. The baseband apparatus 93 includes a processor 94 and a memory 95.

The baseband apparatus 93 may include, for example, at least one baseband board, and a plurality of chips are arranged on the baseband board. As shown in FIG. 9, one of the chips is, for example, the processor 94, which is connected to the memory 95, to invoke a program in the memory 95, so as to perform the operations of the network device shown in the foregoing method embodiment.

The baseband apparatus 93 may further include a network interface 96, configured to exchange information with the radio frequency apparatus 92. For example, the interface is a Common Public Radio Interface (CPRI).

For example, the network side device in this embodiment of the present disclosure further includes an instruction or a program stored in the memory 95 and executable by the processor 94. The processor 94 invokes the instruction or the program in the memory 95 to perform the method performed by the modules shown in FIG. 6, and a same technical effect can be achieved. To avoid repetition, details are not described herein again.

An embodiment of the present application further provides a readable storage medium. The readable storage medium stores programs or instructions. When the programs or instructions are executed by a processor, the processes of the foregoing embodiment of the integrity protection method are implemented, and a same technical effect can be achieved. To avoid repetition, details are not described herein again.

The processor is the processor in the terminal described in the above embodiment. The readable storage medium includes a computer-readable storage medium such as an ROM, a Random Access Memory (RAM), a magnetic disk, an optical disc, or the like.

An embodiment of this application further provides a chip, where the chip includes a processor and a communication interface, the communication interface is coupled to the processor, and the processor is configured to run a program or an instruction to implement the foregoing processes of the foregoing embodiment of the integrity protection method, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of the present application further provides a computer program product. The computer program product is stored in a nonvolatile storage medium. The computer program product is configured to be executed by at least one processor to implement the foregoing processes of the integrity protection embodiments, and a same technical effect can be achieved. To avoid repetition, details are not described herein again.

An embodiment of the present application also provides a communication device, configured to perform each process of the foregoing embodiment of the integrity protection method, and can achieve the same technical effect. To avoid repetition, details are not repeated herein.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the methods and apparatuses in the embodiments of the present application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementation manners, a person skilled in the art may clearly understand that the method in the foregoing embodiment may be implemented by software in addition to a necessary universal hardware platform or by hardware only. In some embodiments, the technical solutions of this application, or the part contributing to the prior art may be implemented in a form of a software product. The computer software product is stored in a storage medium (for example, a ROM/RAM, a magnetic disk, or a compact disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the foregoing implementation manners. The foregoing implementation manners are merely schematic instead of restrictive. Under enlightenment of this application, a person of ordinary skills in the art may make many forms without departing from aims and the protection scope of claims of this application, all of which fall within the protection scope of this application.

1. An integrity protection method, comprising:
calculating, by an integrity protection system, first information; and
performing an integrity check by using the first information to determine the degree of reliability of a target system,
wherein the first information is calculated according to at least one of the following: sampling data of a first communication device, sampling data of a second communication device, or target risk tolerance,
wherein the target system comprises the first communication device and the second communication device.

2. The integrity protection method according to claim 1, wherein the first information is used to indicate at least one of the following:
whether there is abnormal data in the sampling data;
whether the first communication device fails;
whether the second communication device fails; or
whether the target system fails.

3. The integrity protection method according to claim 1, wherein the first information is used for integrity protection of at least one of:
location information, speed information, or clock information of the first communication device.

4. The integrity protection method according to claim 3, wherein the first information is used for integrity protection of the location information, and the method further comprises: receiving second information, wherein the second information comprising at least the following one:
positioning assistance data;
positioning integrity risks;
positioning integrity protection level;
positioning integrity risk alarm level;
reporting time of positioning integrity risk events;
positioning integrity protection threshold;
positioning accuracy requirements; or
integrity indicator requirements.

5. The integrity protection method according to claim 4, wherein the receiving second information comprises: receiving the second information in at least one of the following ways:
receiving second information through paging signaling;
receiving second information through IP packets;
receiving second information through positioning protocol; or
receiving second information through broadcast.

6. The integrity protection method according to claim 4, wherein the method further comprises:
issuing an alarm in a case that the obtained positioning integrity protection level is greater than the positioning integrity risk alarm level, wherein
the positioning integrity protection level is provided by the first communication device, and the positioning integrity risk alarm level is provided by the second communication device; or
the positioning integrity protection level is provided by the second communication device, and the positioning integrity risk alarm level is provided by the first communication device; or
the positioning integrity protection level is provided by the first communication device, and the positioning integrity risk alarm level is provided by the first communication device; or
the positioning integrity protection level is provided by the second communication device, and the positioning integrity risk alarm level is provided by the second communication device.

7. The integrity protection method according to claim 3, wherein the first information is used for integrity protection of the location information, and the performing an integrity check through the first information to determine the degree of reliability of the target system comprises:
performing an integrity check by using the first information and at least one of the following to determine the degree of reliability of a target system:
orbit information or map information of the first communication device.

8. The integrity protection method according to claim 1, further comprising: sending third information to the second network side device, wherein the third information comprises at least one of the following:
the first information;
integrity protection information used by the integrity protection system;
checked first information;
alarm information; or
integrity check information used by the integrity protection system, wherein the check method used by the integrity protection system comprises at least one of the following: first-order Markov process; error model; two-dimensional reverse normal distribution; Bayesian Statistical method; least squares method; Kalman filter; or Neyman-Pearson theorem.

9. The integrity protection method according to claim 1, wherein the first communication device and the second communication device meet one of the following requirements:
the first communication device is a terminal, and the second communication device is a network side device;
the first communication device is a network side device, and the second communication device is a terminal;
the first communication device is a terminal, and the second communication device is a terminal; or
the first communication device is a network side device, and the second communication device is a network side device.

10. The integrity protection method according to claim 9, wherein the network side device comprises at least one of the following:
a radio access network side;
an Authentication Management Function (AMF);
Location Management Function (LMF);
positioning server;
positioning application;
satellite positioning system correction system; or
integrity correction system, wherein intercommunication of integrity capabilities can be realized between at least two network side devices, and the intercommunication method comprises at least one of the following:
interface signaling intercommunication; or
data server sharing.

11. The integrity protection method according to claim 9, wherein the terminal is further configured to report the integrity capability of the terminal to the network side device in at least one of the following ways:
reporting the integrity capability through signaling;
reporting the integrity capability through IP packets; or
reporting the integrity capability through the positioning protocol.

12. The integrity protection method according to claim 9, wherein the network side device is further configured to notify the terminal of the integrity capability of the network side device in at least one of the following ways:
notifying the integrity capability by paging signaling;
notifying the integrity capability through IP packets;
notifying the integrity capability through location protocol; or
notifying the integrity capability through broadcast, wherein the network side device is further configured to notify the terminal of the error information of the network side device through signaling or broadcasting.

13. A non-transitory computer-readable storage medium storing computer programs or instructions that, executed by a processor, cause the processor to perform an integrity protection method comprising:
calculating, by an integrity protection system, first information; and
performing an integrity check by using the first information to determine the degree of reliability of a target system,
wherein the first information is calculated according to at least one of the following: sampling data of a first communication device, sampling data of a second communication device, or target risk tolerance,
wherein the target system comprises the first communication device and the second communication device.

14. The non-transitory computer-readable storage medium according to claim 13, wherein the first information is used to indicate at least one of the following:
whether there is abnormal data in the sampling data;
whether the first communication device fails;
whether the second communication device fails; or
whether the target system fails.

15. The non-transitory computer-readable storage medium according to claim 13, wherein the first information is used for integrity protection of at least one of:
location information, speed information, or clock information of the first communication device.

16. The non-transitory computer-readable storage medium according to claim 15, wherein the first information is used for integrity protection of the location information, and the method further comprises: receiving second information, wherein the second information comprising at least the following one:
positioning assistance data;
positioning integrity risks;
positioning integrity protection level;
positioning integrity risk alarm level;
reporting time of positioning integrity risk events;
positioning integrity protection threshold;
positioning accuracy requirements; or
integrity indicator requirements.

17. The non-transitory computer-readable storage medium according to claim 16, wherein the receiving second information comprises: receiving the second information in at least one of the following ways:
receiving second information through paging signaling;
receiving second information through IP packets;
receiving second information through positioning protocol; or
receiving second information through broadcast.

18. The non-transitory computer-readable storage medium according to claim 16, wherein the method further comprises:
issuing an alarm in a case that the obtained positioning integrity protection level is greater than the positioning integrity risk alarm level, wherein
the positioning integrity protection level is provided by the first communication device, and the positioning integrity risk alarm level is provided by the second communication device; or
the positioning integrity protection level is provided by the second communication device, and the positioning integrity risk alarm level is provided by the first communication device; or
the positioning integrity protection level is provided by the first communication device, and the positioning integrity risk alarm level is provided by the first communication device; or
the positioning integrity protection level is provided by the second communication device, and the positioning integrity risk alarm level is provided by the second communication device.

19. The non-transitory computer-readable storage medium according to claim 16, wherein the first information is used for integrity protection of the location information, and the performing an integrity check through the first information to determine the degree of reliability of the target system comprises:
performing an integrity check by using the first information and at least one of the following to determine the degree of reliability of a target system:
orbit information or map information of the first communication device.

20. A chip, comprising a processor; a communications interface coupled with the processor;
and a memory storing having a computer program storing thereon, wherein the computer program, when executed by the processor, causes the processor to implement an integrity protection method comprising:
calculating, by an integrity protection system, first information; and
performing an integrity check by using the first information to determine the degree of reliability of a target system,
wherein the first information is calculated according to at least one of the following: sampling data of a first communication device, sampling data of a second communication device, or target risk tolerance,
wherein the target system comprises the first communication device and the second communication device.
